(19) United States
(12) Patent Application Publication
(10) Pub. No.: US 2009/0212044 A1
(43) Pub. Date: Aug. 27, 2009

(54) Cooking appliance

(75) Inventors: John Stanton, Herts (GB); Sarah Barrington, Suffolk (GB); David Anderson, Herts (GB)

Correspondence Address: BLACK LOWE & GRAHAM, PLLC, 701 FIFTH AVENUE, SUITE 4800, SEATTLE, WA, 98104, US

(73) Assignee: The Technology Partnership PLC, Royston, Herts (UK)

(21) Appl. No.: 11/911,520

(22) PCT Filed: Apr. 11, 2006
(86) PCT No.: PCT/GB06/01310

§ 371 Date: Apr. 14, 2008

(30) Foreign Application Priority Data
Apr. 12, 2005 (GB) 0507392.9
Jul. 12, 2005 (GB) 0514415.9

(51) Int. Cl. H05B 6/80; A47J 27/04; A47J 27/12

(52) U.S. Cl. 219/682; 99/348; 99/443 R; 219/702

(57) ABSTRACT

The present invention seeks to solve the above problem by providing a cooking appliance comprising a cooking appliance comprising a heating component; an area for receiving, in use, an ingredient storage device comprising a plurality of ingredient locations, each ingredient location storing an ingredient; control means; and a cooking region the appliance being arranged to selectively control, in use, in accordance with instructions provided by the control means, the cooking position of the ingredient locations such that the ingredient in a location is only heated when said location coincides with the cooking region, to bring, in use, the ingredients to readiness for consumption at the same time.

The present invention relates to a cooking appliance which automatically prepares meals.

The convenience food market has grown substantially in recent years in response to a variety of consumer trends. There has been an increase in the number of one-person households and many people are unwilling to make an effort to cook for themselves. An increase in the variety of dietary requirements in most households has also led to a need to quickly cook different meals simultaneously. A decrease in the average amount of free time a person has to enjoy has led to an increased demand for quicker, more convenient meal solutions (the “time-poor”, “cash-rich” consumer).

These trends have led to a large and growing market in chilled or frozen ready meals, which a consumer prepares by heating in a microwave or conventional oven. However, there is an increasing emphasis on the need to eat a healthy diet due to high levels of preventable disease and obesity, together with growing concerns over processed foods, preservatives and, in particular, the provenance of ingredients. The food industry has responded to the healthy eating trend by producing “healthier” versions of ready meals (e.g. versions with less fat or salt), however, ready meals remain frozen, processed and contain artificially preserved foods.

Recently, to further cater to the “health conscious” market, the food industry has produced “ready-to-cook” meal kits which may include some fresh ingredients. However, in order to properly prepare a “ready-to-cook” meal kit, a certain amount of ability and effort is required from the user. Furthermore, “ready-to-cook” meal kits are commonly prepared using a users existing appliances, cookware and dishes, thereby collaterally increasing the amount of effort needed to enjoy a meal.

A variety of dedicated domestic “cooking appliances” are known, for example steam cookers, rice cookers, deep fat fryers, bread makers, pressure cookers, microwaves, electric woks, slow cookers and sandwich makers. However these devices only assist the user with part of the task of preparing a meal and there remains the need to plan, prepare ingredients, control the cooking process, wash-up, etc.

Additionally, in the food service industry, a variety of “cooking appliances” are known for preparing fresh, chilled or frozen food for a large number of people. This is the case in locations such as hospitals, airports and other locations requiring cost-effective mass production of food. Such appliances are required to be operated by a low-skilled workforce. In response to the increased emphasis on healthy eating and more natural ingredients, the food industry is looking for higher, more reliable quality from the food cooked by this low-skilled workforce.

There is thus a clear need for freshly cooked food which can be prepared by anyone, without the use of any skill, judgment or labour.

The present invention seeks to solve the above problem by providing a cooking appliance comprising:

a cooking appliance comprising:

a heating component;

an area for receiving, in use, an ingredient storage device comprising a plurality of ingredient locations, each ingredient location storing an ingredient;

control means; and

a cooking region;

the appliance being arranged to selectively control, in use, in accordance with instructions provided by the control means, the cooking position of the ingredient locations such that the ingredient in a location is only heated when said location coincides with the cooking region, to bring, in use, the ingredients to readiness for consumption at the same time.

An example of the present invention is described below with reference to the accompanying drawings, in which:

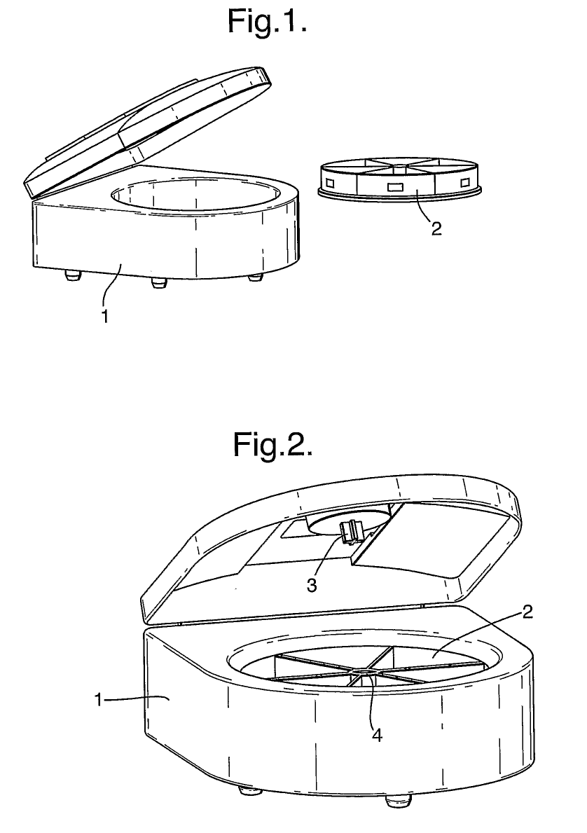

FIGS. 1 to 5 show a cooking appliance according to a first example of the present invention;

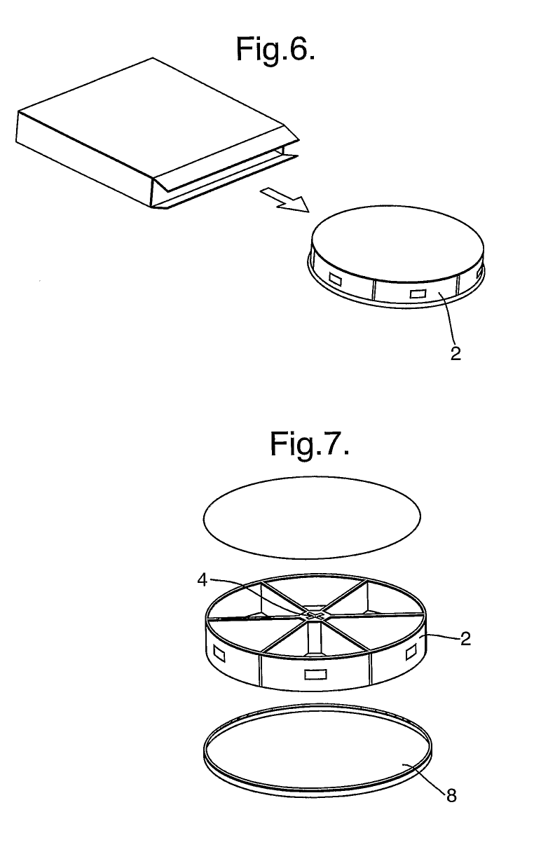

FIG. 6 and FIG. 7 show an ingredient storage device according to the first example of the present invention.

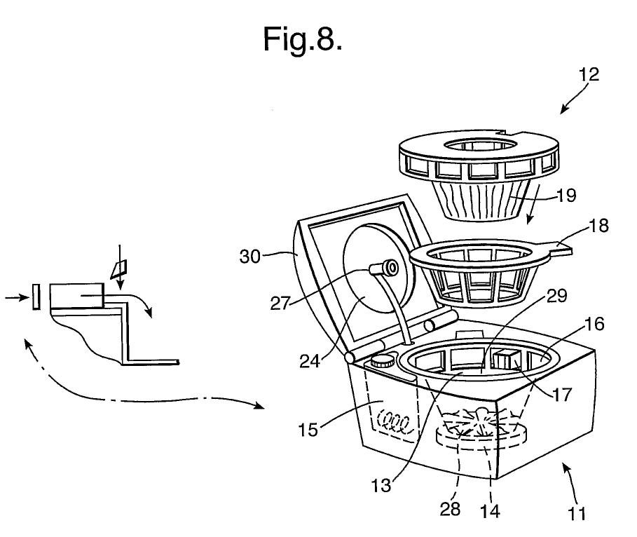

FIG. 8 shows a cooking appliance according to a second example of the present invention; and

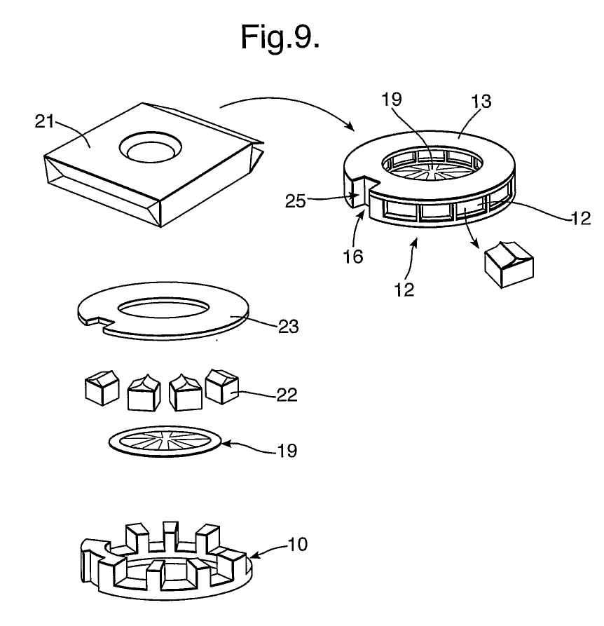

FIG. 9 shows an ingredient storage apparatus according to the second example of the present invention.

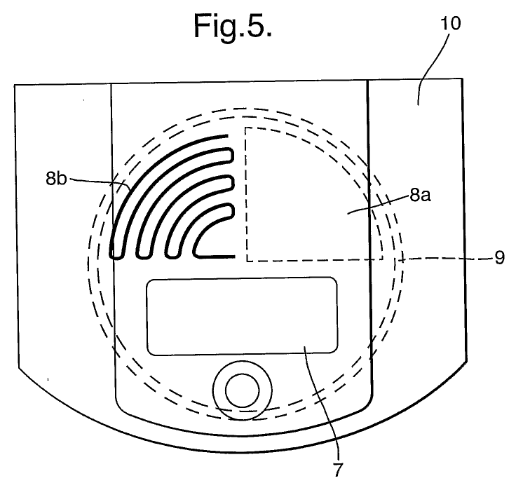

A first example cooking appliance 1 according to the present invention will now be described with reference to FIGS. 1 to 5. In this example a cooking appliance 1 has a heating component comprising, for example, a microwave cooker and a grill, although radiant sources of heat, such as an infra red heater could be used alternatively or additionally. There is a volume 10 (see FIG. 5) of the appliance I for containing microwave components (not shown) such as a magnetron. A steaming function (not shown) may also be present, for example by means of a water layer heated by a microwave component or standard heating element such as that found in a kettle. The water layer may be part of the appliance 1 or part of an ingredient pouch. The cooking appliance I receives an ingredient storage device 2 (see also FIG. 6 and FIG. 7). The cooking appliance 1 has associated control circuitry (not shown).

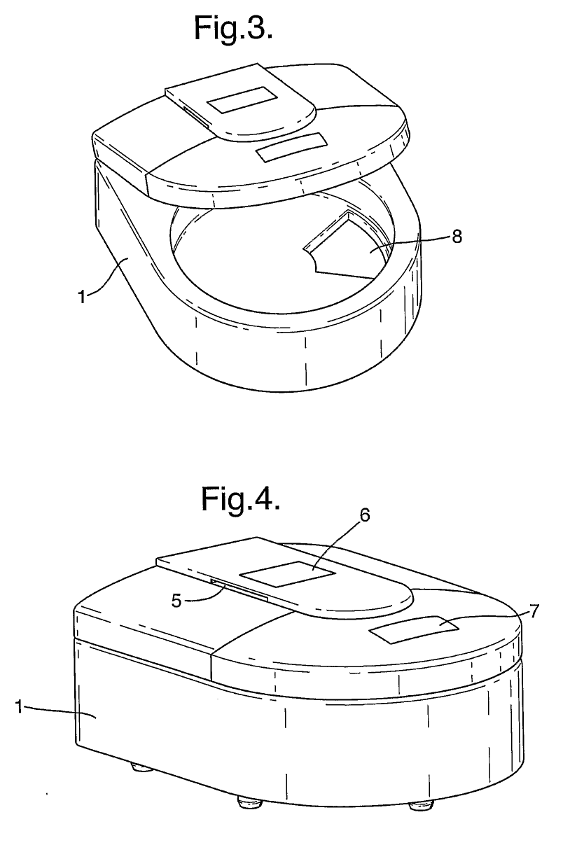

In this example, as shown in FIG. 3 and FIG. 5, the cooking appliance 1 comprises a first cooking region 8a defined by a microwave window and a second cooking region 8b defined by a grilling region. However, as will be appreciated, different numbers of cooking regions of different shapes and sizes and for different combinations of heat and microwave sources may be contemplated.

The cooking appliance 1 further comprises a code sensor (not shown in this example). The code sensor is attached to control circuitry (not shown) which regulates the operation of the appliance 1. As will be appreciated, other devices such as network connected computing devices, mobile phones, Radio Frequency Identification tags (RFID) or magnetic tags, may be readily used to provide instructions to the control circuitry.

An ingredient storage device 2 is, in this example, circular with each ingredient storage location being defined as a sector of the circle. The ingredient storage device 2 rotates about a central axis and the cooking appliance 1 comprises an indexing spigot 3, shown as being located in the lid of the appliance 1 in FIG. 2, which is connected with a turntable 9 which engages with the axis of rotation 4 of the ingredient storage device 2 to drive the rotation of the ingredient storage device 2. In an alternative arrangement, the ingredient storage device 2 may be driven from below rather than by a driving means in the lid. Alternatively the ingredient storage device 2 does not move in use and instead the microwave source or other heating component may move. It should be noted that ingredient storage devices of various shapes (e.g. cubes, strips and squares) may also be possible.

As shown in FIG. 6, the ingredient storage means 2 may be supplied in a “pizza-style” box, which is easy to handle and store. The “pizza-style” box 11 and the ingredient storage device 2 may all be disposable. The ingredient storage device 2 may either be supplied prefilled with different ingredients (which may be in ingredient pouches) in the different sectors or alternatively, a user may separately purchase ingredient pouches and place the ingredient pouches in different sectors of a ingredient storage device 2 supplied empty of ingredients, in accordance with instructions provided with the pouches and/or the ingredient storage device 2 and/or the cooking appliance 1. A user selected ingredient pouch may have a visual identity code which controls the heating of the ingredients stored therein. Alternatively, the user may program the cooking appliance 1 or the ingredient storage device 2 in which the pouches are placed with a set of instructions about which ingredient is in which sector. There may be one ingredient per sector or several ingredients per sector, depending on the cooking requirements of the different ingredients making up a meal.

The cooking appliance 1 optionally comprises, on its lid in this example, ventilation slots 5, a viewing window 6 and a programming display 7.

The microwave window 8a in the cooking appliance I enables microwaves to be directed towards only a part of the volume of the cooking appliance 1 in use. As can be seen most clearly in FIG. 7, the ingredient storage device 2 is divided up into different locations, which are compartmentalised in this example, and the microwave window 8a corresponds to the area of one compartment when the ingredient storage device 2 is installed in the cooking appliance 1, the grilling region 8b corresponding to the area of a second compartment.

In order to cook a meal, a consumer loads the ingredient storage device 2 containing the ingredients into the cooking appliance 1. Once the ingredient storage device 2 is properly loaded in the cooking appliance 1, the user then closes the lid. The control circuitry (not shown) responds to the closing of the lid and the control means reads the instructions on the ingredient storage device 2 to control the cooking conditions of the ingredients in the different locations of the ingredient storage device 2. These conditions may include, for example, the heating and/or microwaving method used, duration of heating and power used.

Firstly, the control device controls relative movement of the ingredient storage device 2 and the heating component so that the sectors of the ingredient storage device 2 become aligned with the required part of the heating component. The control device then controls any relative movement of the ingredients and parts of the heating component required during cooking. In this example, the ingredient storage device 2 rotates while microwaves cook the food through the microwave window 8a and food in the grill region 8b is grilled by a grill. The control device may control the times at which microwaves are emitted and the intensity of the radiation to ensure that all of the ingredients are ready at the same time. For example, ingredients which do not take long to cook can be microwaved only on alternate passes through the microwave window at a low intensity, while other ingredients which take longer to cook can be microwaved on every pass at a higher intensity. A user may monitor the appliance's operation through a window in the lid of the appliance 1.

When the meal is ready to eat the user is alerted. At the end of the cooking period all the ingredients may be microwaved at low intensity to keep the meal hot.

The ingredient storage device 2 or individual ingredient pouches may be designed to have barrier properties to prevent heat or microwaves from entering the wrong sector of the ingredient storage device 2 when cooking is taking place. The ingredient storage device 2, individual ingredient pouches or other components of the cooking appliance 1 may further have microwave focussing properties to improve the efficiency of the microwave cooking.

As shown in FIG. 7, the ingredient storage device 2 may comprise a removeable plate portion. When the meal is ready to be eaten and the ingredient storage device 2 is removed from the cooking appliance 1, the plate portion may be removed from the ingredient storage device 2 and used as a conventional dinner plate from which to eat the meal.

The control means operates to cook the meal with no input required from the user. This cooking device is suitable for a meal which does not require any mixing of ingredients, but simply comprises different ingredients that require different cooking times and/or cooking temperatures and/or cooking methods. In this way, freshly cooked meals can be produced from raw ingredients with no skill, recipe planning or sourcing of special ingredients. Portions are automatically controlled. Further there is no waste and the process is energy efficient.

With reference to FIG. 8, the features of a second example cooking appliance 11 shall now be described. In this example, the cooking appliance 11 comprises a base which can be made of any easily cleaned material. Within the base is a cooking region 29. At the base of the region, there may be a rotary mixing device 14 which may include radially disposed ribs 28. The circular mixing device 14 may also include a heating element (not shown).

At the uppermost rim of the cooking region, there may be a rotating ring 16, on which may be disposed a code sensor 17.

There is also provided on the uppermost rim, a dispensing device 13. The cooking region 29 may be lined with a removable basket 18. The appliance may also includes a heated water reservoir 15 and a water pipe 27 which dispenses, when required, water from the water reservoir 15 to the cooking region 29. A lid 30 is hingedly connected to the base and may include a window 24 for viewing the contents of the cooking region 29.

Now, with reference to FIG. 9, the features of a second example ingredient storage device 12 will now be described. In this example, the ingredient storage device 12 comprises a circular frame 20 made of any suitably light-weight thermally resistant material. In this example, the circular frame 20 has a plurality of radially and peripherally disposed compartments, each suitable for accepting an ingredient pouch 22. A flexible cooking receptacle 19 may be disposed in the centre of the ingredient storage device 12 and may, when not in use, be folded in order to adopt a more compact form. The flexible cooking receptacle 19 can be made of metal foil or any suitable thermally conductive material.

Furthermore, a perforated steaming receptacle (not shown), suitable for containing ingredients while they are steamed, may be included within the flexible cooking receptacle 19 and may be similar in shape to the cooking receptacle 19.

The ingredient storage means 12 may further comprise an annular lid 2 which prevents the ingredient pouches 22 from being dislodged from their respective compartments. A slot 26 within the frame 20 may be coded with machine-readable instructions 25 which are indicative of how the cooking appliance 11 should dispense and cook the contents of the ingredient pouches 22. The machine-readable instructions 25 may take the form of optically readable marks, indentations, or raised features.

Now, with reference to both FIGS. 8 and 9, in use, the consumer loads the ingredient storage device 12 into the cooking region 29 of the cooking appliance 1. When loaded in the cooking appliance 11, the ingredient storing device 12 sits on top of a removable basket 18 which supports the flexible cooking receptacle 19. Once the ingredient storage device 12 is properly loaded in the cooking region 19, the user then closes the lid 30. The control circuitry (not shown) responds to the closing of the lid 30 and, in this example, proceeds to read the instructions 25 on the side of the ingredient storage device 12 using the code sensor 17. The instructions 25 may include rate of addition, heating and stirring requirements, as well as the timing for moving on to open the next pouch 22 and instructions for adding water from the reservoir, A user may monitor the appliance's operation through the window 24 in the lid 30.

Then, in accordance with the instructions 25 which the code sensor 17 has read on the ingredient storage device 12, the control circuitry (not shown) operates to control the dispensing, stirring and heating of the ingredients as well as the addition of water to the cooking receptacle 19. In this example, the frame 20 rotates so that pouches 22 move in turn past the dispense position where the pouches 22 are opened and their contents added to the flexible cooking receptacle 19 by means of the dispensing device 13. The dispensing device 13 simultaneously opens a pouch 22 and pushes its contents into the flexible cooking receptacle 19.

Hot or cold water may also be added to the meal at appropriate times from a heated reservoir 15 contained within the appliance and dispensed through the water pipe 27. The perforated steaming receptacle (not shown) is operable to hold the ingredients above the water level created by water which may be introduced between the perforated steaming receptacle (not shown) and the flexible cooking receptacle 9. The heating element (not shown) of the mixing device 14 is operable to boil water so that steam may be introduced through the perforations of the perforated steaming receptacle (not shown). Furthermore, the mixing device 4 may be elevated in order to permit mixing of the ingredients in the perforated steaming receptacle (not shown) using the radially disposed ribs 28.

The rotary mixing device 14 stirs the ingredients by agitation of the flexible cooking receptacle 19. As mentioned above, the rotary mixing device 14 may also comprises a heating element (not shown) which permits the contents of the flexible cooking receptacle 19 to be heated.

What is claimed:

1. A cooking appliance comprising:
a heating component;
an area for receiving, in use, an ingredient storage device comprising a plurality of ingredient locations, each ingredient location storing an ingredient; control means; and
a cooking region;
the appliance being arranged to selectively control, in use, in accordance with instructions provided by the control means, the cooking position of the ingredient locations such that the ingredient in a location is only heated when said location coincides with the cooking region, to bring, in use, the ingredients to readiness for consumption at the same time.

2. The cooking appliance according to claim 1, wherein the appliance further being arranged to control, in use, in accordance with instructions provided by the control means, the cooking time of the ingredients stored in different ingredient locations.

3. The cooking appliance according to claim 1 wherein, the appliance being further arranged to control, in use, in accordance with instructions provided by the control means, the cooking method of the ingredients stored in different ingredient locations.

4. The cooking appliance according to claim 1, wherein the heating component is arranged to vary, in use, the cooking temperature of the ingredients at different stages of cooking, in accordance with the instructions provided by the control means.

5. The cooking appliance according to claim 1, wherein the heating
component is arranged to vary, in use, the cooking temperature of the ingredients, depending on which ingredient location coincides with the cooking region, in accordance with the instructions provided by the control means.

6. A cooking appliance according to claim 1, wherein the heating
component is arranged to heat discontinuously, in use, in accordance with the instructions provided by the control means.

7. A cooking appliance according to claim 6, wherein the heating component is arranged to heat discontinuously depending on which ingredient location coincides with the cooking region.

8. A cooking appliance according to claim 1, wherein the heating
component and the ingredient storage device are moveable relative to each other.

9. A cooking appliance according to claim 8, wherein the appliance is arranged such that the ingredient storage device is rotatable about a central axis and each location on the ingredient storage device passes, in use, through the cooking region at least once per revolution of the ingredient storage device.

10. A cooking appliance according claim 9, wherein at least one of the locations is heated during only some of its passes through the cooking region.

11. The cooking appliance according to claim 1, wherein the heating component comprises one of a microwave source, or a steamer.

12. (canceled)

13. (canceled)

14. The cooking appliance according to claim 11, wherein the microwave source is arranged to vary, in use, the intensity of the microwaves emitted.

15. The cooking appliance according to claim 11, wherein the cooking region is defined by a microwave window.

16. The cooking appliance according to claim 13, wherein the microwave source is arranged, in use, such that the direction of emission of the microwaves is variable.

17. The cooking appliance according to claim 1, comprising a
plurality of cooking regions;
wherein the heating component comprises one or more plurality of heat or microwave sources associated with the plurality of cooking regions.

18. (canceled)

19. The cooking appliance according to claim 11, wherein the steamer comprises
a water storage means arranged to store water for conversion into steam for steaming of the ingredients.

20. The cooking appliance according to claim 16, wherein the heating component
comprises one of a heating element or a microwave source for heating the water in the water storage means.

21. (canceled)

22. (canceled)

23. The cooking appliance according to claim 1, wherein the control means comprises at least one of a keypad, a network connected computing device, a mobile telephone or an instruction input device operable to read at least one of an optically detectable code, a series of protuberances or grooves, a Radio Frequency Identification tag (RFID) or a magnetic tag.

24. (canceled)

25. The cooking appliance of claim 1, wherein the ingredient storage device is at east one of provided with preselected individually packaged ingredients or device is operable to house individually packaged ingredients selected by a user.

26. (canceled)

27. The cooking appliance of claim 19, wherein the individually packaged ingredients selected by the user each comprise a visual code.

28. The cooking appliance of claim 19, An Ingredient storage device according to any of claims 24 to 27, wherein
the ingredient storage device is at least one of annular in shape and the plurality of individually packaged ingredients are disposed peripherally or circular in shape and the ingredient storage locations are sectors of a circle.

29. (canceled)

30.-34. (canceled)

35. The cooking appliance according to claim 22, further comprising stirring
means for stirring the ingredients in the cooking region at different stages of cooking and in accordance with instructions provided by the control means.

36. (canceled)

37. The cooking appliance of claim 23, further comprising a
cooking receptacle, wherein the cooking receptacle and the ingredient storage device form a single unit, the cooking
receptacle is attached to the centre of the annularly shaped ingredient storage device

38. (canceled)

39. The cooking appliance of claim 23, further
comprising a perforated steaming receptacle positioned within the cooking receptacle and operable to hold the ingredients above a certain height within the cooking receptacle; and a removable plate portion from which, in use, the cooked ingredients may be eaten.

40. (canceled)

41. (canceled)
